(19) United States
(12) Patent Application Publication
(10) Pub. No.: US 2014/0157810 A1
(43) Pub. Date: Jun. 12, 2014

(54) REFRIGERATOR

(71) Applicant: Dongbu Daewoo Electronics Corporation, Seoul (KR)

(72) Inventor: Won Woo JANG, Incheon (KR)

(73) Assignee: Dongbu Daewoo Electronics Corporation, Seoul (KR)

(21) Appl. No.: 14/080,673

(22) Filed: Nov. 14, 2013

(30) Foreign Application Priority Data
Dec. 11, 2012 (KR) 10-2012-0143499

(51) Int. Cl. F25C 1/24; G08B 21/18; E03C 1/02

(52) U.S. Cl. CPC F25C 1/24; E03C 1/02; G08B 21/182
USPC 62/129; 137/558; 137/565.17; 340/606

(57) ABSTRACT

The present disclosure relates to a refrigerator including an ice maker in a freezer compartment of the refrigerator; a dispenser on a door of the refrigerator; a water tank in the interior of a cold storage unit of the refrigerator, at a height lower than the height of the dispenser; a pump adapted to pump water in the water tank to the ice maker or the dispenser; a passage adapted to connect the water tank to the pump; a flow sensor on or in communication with the passage to sense a flow rate of water in the passage; and a controller adapted to receive a signal from the flow sensor and determine whether water exists in the water tank.

### BACKGROUND OF THE INVENTION

1. Field of the Invention

The present invention relates to a refrigerator, and more particularly, to a refrigerator in which purified water, not directly connected with a tap, is stored in a tank on a shelf in the interior of the refrigerator and supplied to an ice maker and/or a dispenser in the refrigerator.

2. Background of the Related Art

Generally, a refrigerator is a household appliance adapted to maintain the inside of a cold storage unit and a freezer compartment to low temperatures through the repetition of a refrigeration cycle in which a refrigerant is compressed, condensed, expanded and evaporated, thereby keeping the food stored therein in a fresh state for a given period of time.

Accordingly, the refrigerator is provided with a compressor adapted to compress the refrigerant, a condenser adapted to condense the refrigerant from the compressor using external air, an expansion valve adapted to reduce the pressure of the refrigerant from the condenser, and an evaporator adapted to absorb the heat in the interior of the refrigerator through the evaporation of the refrigerant passing through the expansion valve at a low pressure.

Also, the refrigerator generally includes a body that forms an accommodating space partitioned into a cold storage unit and a freezer compartment or freezer, doors mounted on the front surface of the body to open and close the cold storage unit and the freezer, and a machine compartment in the body and having the compressor and condenser mounted therein.

With the change and development of food quality and culture, recently, the size and function of the refrigerator have increased, and further, refrigerators having various structures and convenience devices have been developed and marketed for the user's convenience.

Representative examples of the convenience devices of the refrigerator include an ice maker in the freezer to automatically make ice using the sequential operations of water feeding, ice making and ice ejecting, and a dispenser on the door to provide drinkable water.

Additionally, the refrigerator is provided with a water supply line connected directly to a tap to supply water to the ice maker and the dispenser, a water tank that stores the water from the water supply line, and a valve adapted to open and close the supply of water from the tap.

Accordingly, only when the water supply to the ice maker or the dispenser is needed, the valve is opened by a controller that conducts or controls the water supply operation.

On the other hand, water may be supplied to the ice maker or the dispenser from the water tank storing purified water, rather than water directly from a tap. Unfortunately, there is no mechanism for sensing whether water is in the water tank. In this case, the user may mistakenly understand that the ice maker or the dispenser is malfunctioning or broken.

In the conventional practice, accordingly, there is no mechanism for notifying the user of the complete consumption or absence of water in the water tank, thereby making it inconvenient to use the ice maker and the dispenser. As a result, the user is reluctant to use them, which undesirably causes the convenience devices and/or functions of the refrigerator to not be fully utilized.

### SUMMARY OF THE INVENTION

Accordingly, the present invention has been made in view of the above-mentioned problems occurring in the prior art, and it is an object of the present invention to provide a refrigerator including a water tank configured to contain water that may be purified, rather than directly from a tap, is in or on a shelf in the interior of the refrigerator and configured to supply the water to an ice maker and/or a dispenser, and the level of water in the water tank is sensed to prevent the water in the water tank from being completely drained or used.

To accomplish the above object(s), according to the present invention, there is provided a refrigerator including a water tank in a cold storage unit (e.g., of the refrigerator); a pump adapted to pump water in the water tank to an ice maker or a dispenser; a passage adapted to connect the water tank to the pump; a flow sensor on or in communication with the passage to sense a flow rate of water (e.g., in the passage); and a controller adapted to receive a signal from the flow sensor and determine whether water exists (e.g., in the water tank).

According to the present invention, desirably, the flow sensor includes a plurality of blades rotated by the flowing water (e.g., in the passage).

According to the present invention, desirably, the refrigerator further includes a warning device adapted to notify a user of a non-existence or absence of water (e.g., in the water tank), for example in accordance with a control signal from the controller.

According to the present invention, desirably, the warning device comprises a lamp or a sound generator such as a speaker.

According to the present invention, desirably, when the flow rate of water is zero (i.e., is not sensed) by the flow sensor and the dispenser or the ice maker is not used, the control signal corresponds to a presence or existence of water (e.g., water is in the water tank); when the flow rate of water is greater than zero (i.e., is sensed), and optionally the dispenser or the ice maker is operated, the control signal does not allows the warning device to be turned on; and when the dispenser or the ice maker is operated and the flow rate of water is zero (i.e., not sensed), the control signal allows the warning device to be turned on.

According to the present invention, desirably, the water tank is configured to slide or move on a shelf in the interior of the cold storage unit, and the water tank comprises an outlet on a rear surface thereof configured to supply water to the ice maker or the dispenser, and a pipe connector extending from an interior of the water tank and connected to the outlet.

According to the present invention, desirably, the pipe connector curves or bends toward a bottom surface of the water tank from the rear surface of the water tank.

According to the present invention, desirably, the pipe connector has an inlet facing the bottom surface of the water tank.

According to the present invention, desirably, the inlet of the pipe connector is separated or spaced apart from the bottom surface of the water tank.

According to the present invention, desirably, the pipe connector has a filter on the inlet.

According to the present invention, desirably, the filter has a plurality of separate protrusions along an outer periphery of the filter (e.g., and on an underside surface of the filter), wherein the protrusions are configured to contact the bottom surface of the water tank.

### BRIEF DESCRIPTION OF THE DRAWINGS

The above and other objects, features and advantages of the present invention will be apparent from the following detailed description of various embodiments of the invention in conjunction with the accompanying drawings, in which:

FIG. 1 is a front view showing an exemplary refrigerator according to the present invention;

FIG. 2 is a front view showing open doors in the exemplary refrigerator of FIG. 1;

FIGS. 3a and 3b are perspective views showing the exemplary water tank of FIG. 2;

FIG. 4a is an exploded perspective view of the exemplary water tank of FIG. 3b;

FIG. 4b is a cross-sectional view of the exemplary water tank of FIG. 3b;

FIG. 4c is a partially enlarged view of part of FIG. 4b;

FIGS. 5a and 5b are perspective views showing an exemplary pump in the refrigerator according to the present invention;

FIG. 6 is a block diagram showing the exemplary detection unit for water in the water tank of the refrigerator according to the present invention;

FIG. 7 is a front view showing an exemplary passage or route of a dispenser tube in the refrigerator according to the present invention; and

FIG. 8 is a front view showing an exemplary passage or route of a tube for transporting water to an ice maker in the refrigerator according to the present invention.

### DETAILED DESCRIPTION

Hereinafter, an explanation of an exemplary refrigerator according to the present invention will be given in detail with reference to the attached drawings.

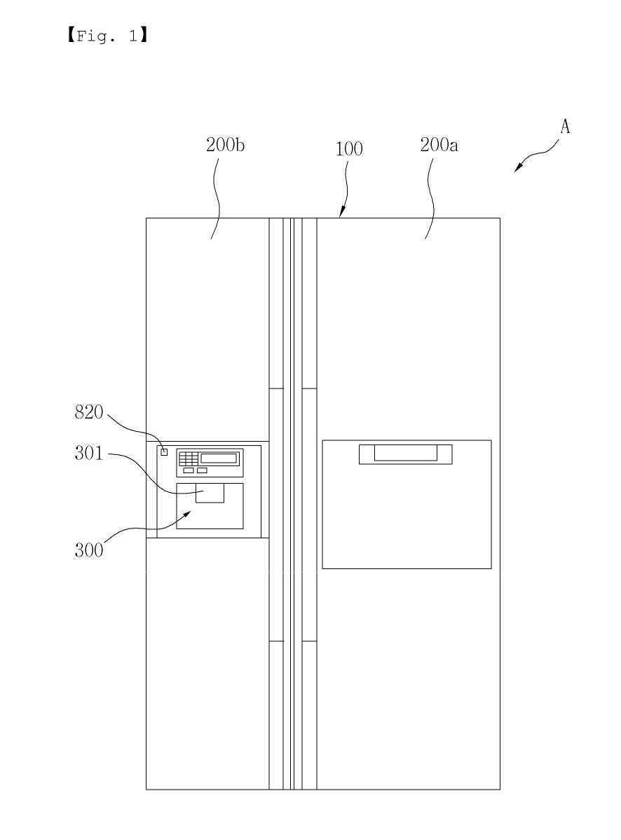

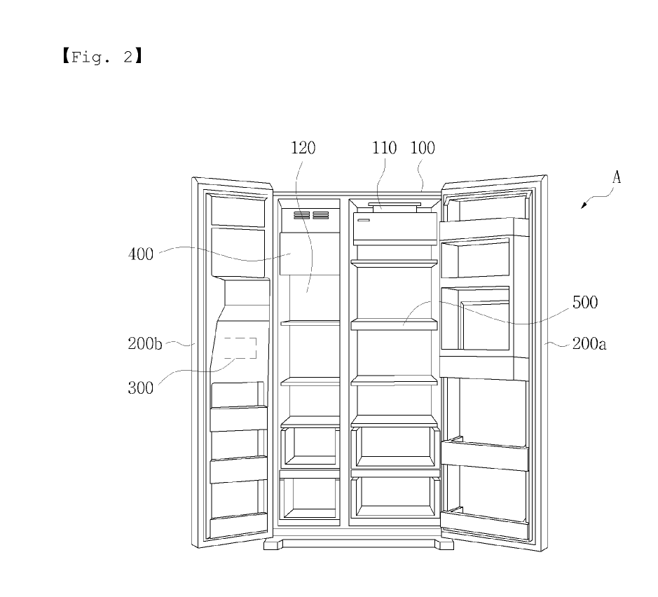

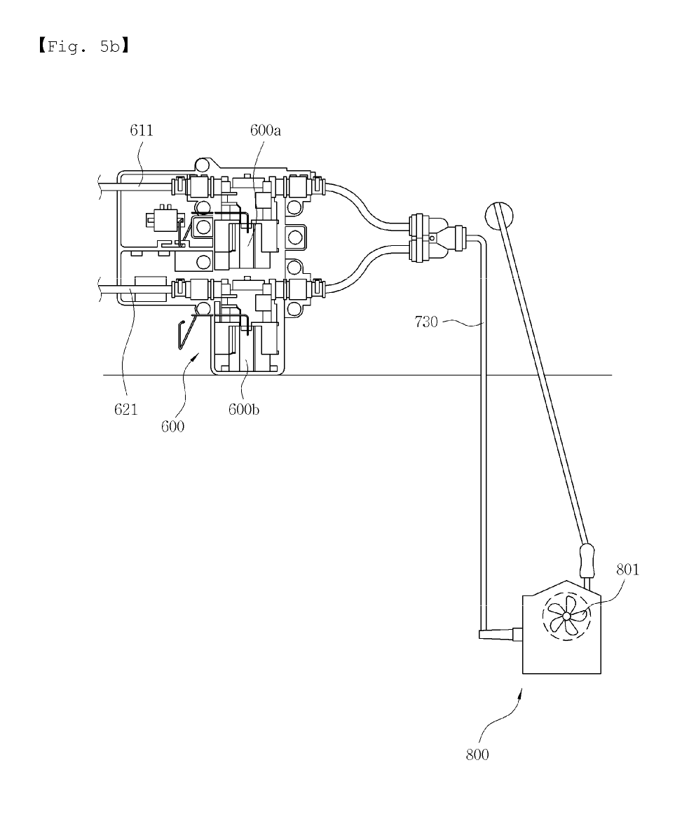

Referring to FIGS. 1 to 8, first, an internal structure of a refrigerator according to the present invention will be explained, and the exemplary refrigerator A according to the present invention generally includes a body 100 containing a cold storage unit 110 and a freezer 120 in left and right sides (see FIG. 1), or in upper and lower sections (not shown). Such an arrangement may form an accommodating space therein. The exemplary refrigerator A further includes doors 200a and 200b mounted on the body 100 to open and close the cold storage unit 110 and the freezer 120, and a machine compartment 130 in the lower portion of the body 100 configured to securely house mechanical devices (not shown) such as a compressor, a condenser and the like therein.

Further, the refrigerator A includes a dispenser 300 on the door 200b, from which cold water is directly discharged dispensed to a user. The dispenser 300 may also dispense ice (e.g., ice cubes, crushed ice, or a combination thereof) to the user.

Furthermore, the freezer 120 has an ice maker 400 therein, in which ice is made by the sequential operations of water feeding (e.g., to the ice maker 400), ice making, and ice ejecting (e.g., into an ice bin in the freezer 120) in an automatic manner.

On the other hand, the cold storage unit 110 has a water tank 500 in the interior thereof.

Further, the water tank 500 may slide, latch or move onto a shelf 520 in the cold storage unit 110, and the shelf 520 may be inserted onto or between rails on the side walls of the cold storage unit 110.

Also, the refrigerator A further includes a pump 600 adapted to pump the water in the water tank 500 to the ice maker 400 and the dispenser 300, and a passage 700 adapted to connect the water tank 500 to the pump 600.

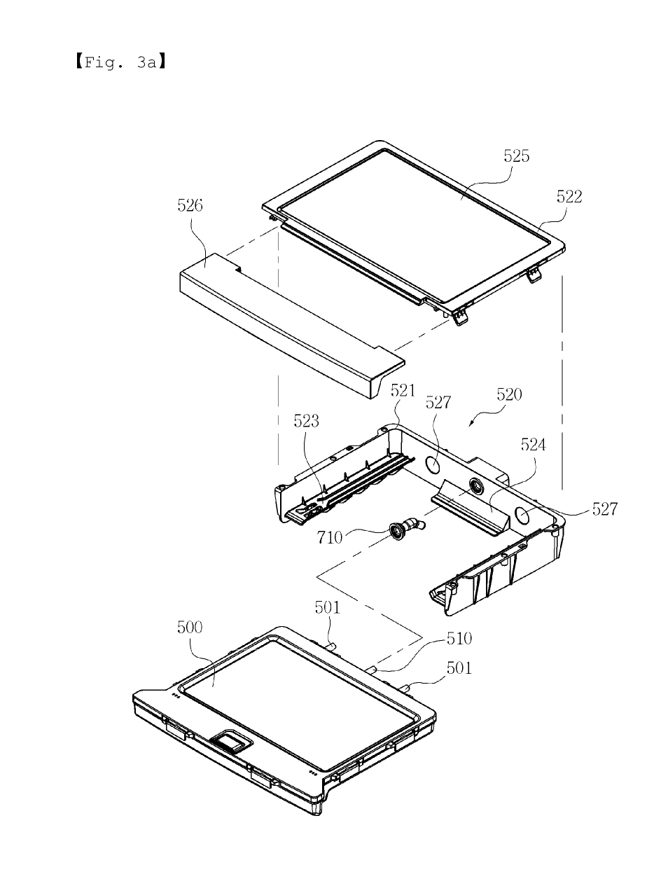

As shown in FIGS. 3a and 3b, the water tank 500 and/or shelf 520 has an outlet 510 and a silicone inlet 710 on a rear surface thereof, depending on whether the shelf 520, the water tank 500, or both the water tank 500 and the shelf 520 have a rear surface. In the example shown in FIGS. 3a and 3b, the silicone inlet 710 has one end connected to the outlet 510 of the water tank 500 and another (e.g., opposite) end connected to the passage 700.

The silicone inlet 710 may have a funnel shape, in which a diameter of the outer peripheral surface and internal passage may decrease from one end to the other (opposite) end, so that a tube 730 as will be discussed later can be fitted to the inner or outer peripheral surface of an end portion of the silicone inlet 710. The end portion of the silicone inlet 710 receiving the tube 730 may have a smaller cross-sectional area than the opposite end of the silicone inlet 710.

Also, the shelf 520 includes a shelf body 521 adapted to support the water tank 500 and a cover 522 adapted to cover the top portion of the shelf body 521.

Further, the silicone inlet 710 may be on a portion of the shelf body 521 facing the inner or rear wall of the cold storage unit 110.

The shelf body 521 has guides 523 on opposed sides thereof, and a sagging prevention member or brace 524 between the guides 523 to stably support the underside of the water tank 500.

Further, the cover 522 has a transparent window 525 to enable visual checks of the water tank 500 in the shelf 520.

Also, the cover 522 may have a rotary door 526 coupled thereto (e.g., using one or more hinges), configured to be open and closed.

On the other hand, the water tank 500 has coupling protrusions 501 thereon, and the shelf body 521 has coupling grooves or openings 527 therein corresponding to the coupling protrusions 501, enabling the water tank 500 to be guided, positioned and/or rigidly fixed to the shelf body 521.

Furthermore, the coupling grooves or openings 527 are coupled to the inner or rear wall of the cold storage unit 110 by mechanical fasteners such as nuts and bolts, or hooks and openings. That is, the shelf 520 is fixed to the cold storage unit 110, and the water tank 500 can be withdrawn from the shelf 520.

Also, the shelf body 521 or water tank 500 may have a fitting protrusion 528 thereon, and the silicone inlet 710 has a fitting groove or slot 711 therein. The fitting protrusion 528 is configured to be inserted into the fitting groove or slot 711, thereby being rigidly fixed to the shelf body 521.

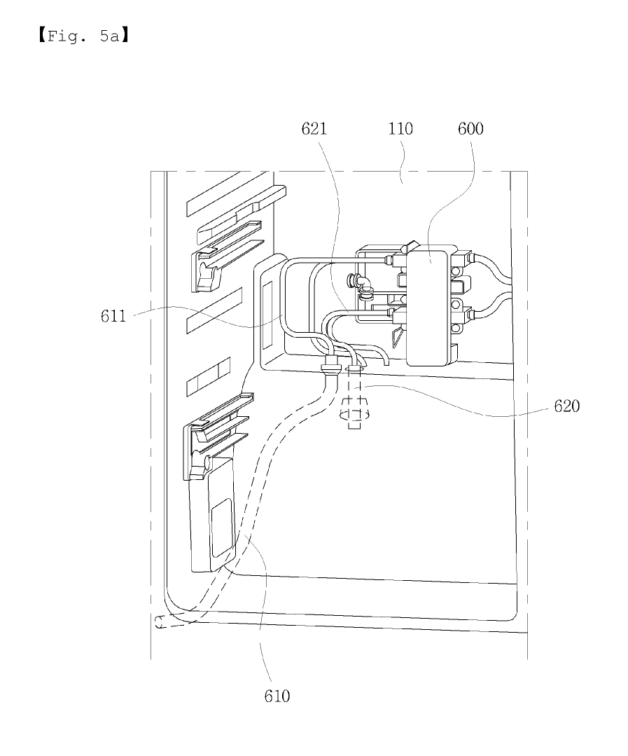

Also, as shown in FIGS. 5a and 5b, the pump 600 is on or in a lower portion of the cold storage unit 110. In one example, the pump 600 is behind a vegetable compartment (not shown), and includes a first guide 610 that may be adapted to connect the lower portion of the cold storage unit 110 and the front surface of the lower portion of the freezer 120 to each other, and a second guide 620 that may be adapted to connect the lower portion of the cold storage unit 110 and a machine compartment (not shown) on the rear surface of the refrigerator.

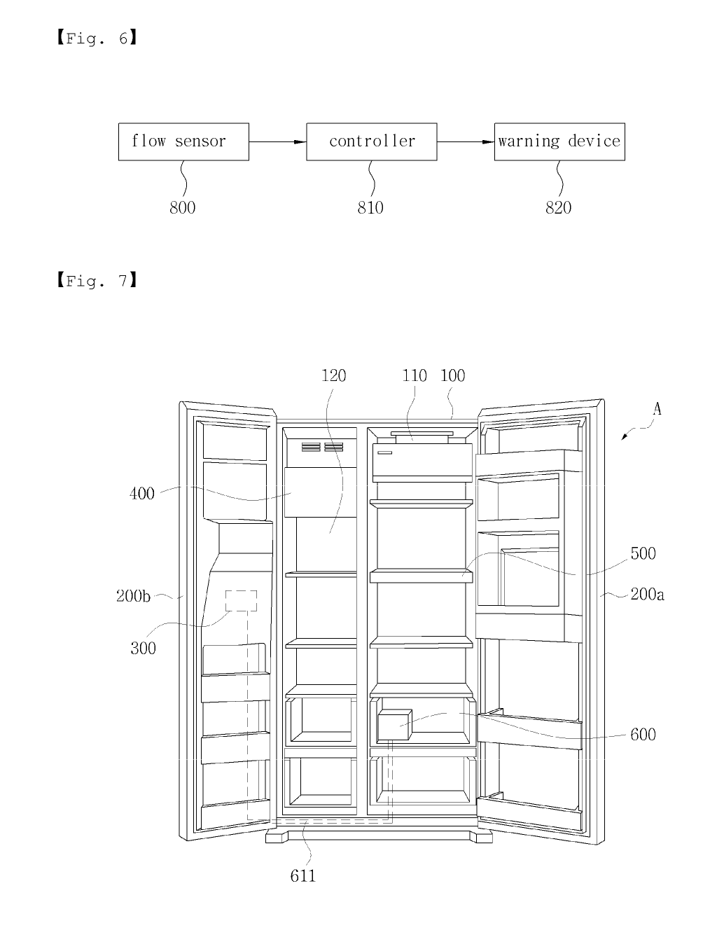

As shown in FIG. 7, a dispenser tube 611 may be on, in or along the first guide 610, and may connect the pump 600 to the dispenser 300. The dispenser tube 611 is routed from the pump 600, along the front surface of the lower portion of the freezer 120, and is connected to the dispenser 300 in the door 200b of the freezer 120.

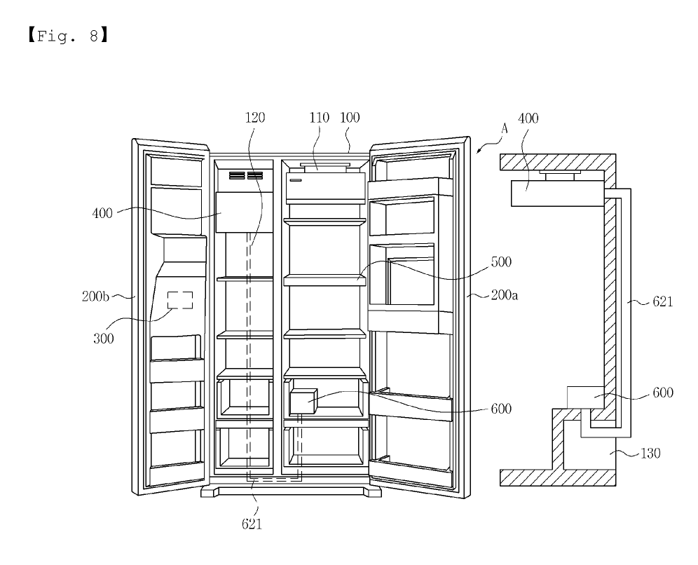

On the other hand, as shown in FIG. 8, an ice maker tube 621 is on, in or along the second guide 620 to connect the pump 600 to the ice maker 400. The ice maker tube 621 extends from the pump 600 to the freezer 120 through the machine compartment on the rear surface of or behind the cold storage unit 110 and the freezer 120, and is connected to the ice maker 400 near the top of the freezer 120.

Accordingly, the water tank 500 in which purified water, rather than tap water, may be stored is accommodated in the shelf 520 in the interior of the cold storage unit 110, and supplies water to the ice maker 400 and the dispenser 300 using the pump 600.

Further, the water tank 500 is not exposed to the external air, and cold water can be supplied to the dispenser 300. Furthermore, the water in the water tank 500 being cooled in the refrigerator A is supplied to the ice maker 400, thereby shortening the ice making time.

Also, the water tank 500 is fastened or attached to the shelf 520 in the cold storage unit 110, thereby also serving as a shelf.

On the other hand, the tube 730, the dispenser tube 611 and the ice maker tube 621 are fixed or connected to components such as the silicone inlet 710, the pump 600, the dispenser 300 and the ice maker 400 by one or more elastic materials and/or tube fitting(s), and a detailed explanation of the fixing or connection(s) will be avoided.

Further, as shown in FIGS. 5a and 5b, the pump 600 includes a dispenser pump 600a and an ice maker pump 600b, and the dispenser pump 600a is driven when an operating lever 301 of the dispenser 300 is contacted or depressed by a user's manipulation, while the ice maker pump 600b is automatically driven in accordance with the amount or period of water supply inputted, programmed or demanded by the user (e.g., in the case of the user's demand, based on a depth or level of the ice in the ice bin in the freezer).

If the ice maker pump 600b is programmed or otherwise controlled to pump water to the ice maker 400 when the dispenser pump 600a is pumping water to the dispenser 300, the ice maker pump 600b remains idle until the dispenser pump 600a finishes pumping water to the dispenser 300.

However, if the dispenser pump 600a is driven while water is pumped by the ice maker pump 600b, the ice maker pump 600b and the dispenser pump 600a can pump water at the same time.

A flow sensor 800 (FIG. 5b) is connected to the tube 730 between the water tank 500 and the pump 600. The flow sensor 800 is configured to sense whether water exists or not (e.g., in the water tank 500 and/or in the tube extending from the hole or opening in the upper right portion of FIG. 5b to an upper surface of or input to the flow sensor 800).

As may be shown in FIG. 5b, the flow sensor 800 generates and transmits a signal corresponding to the revolutions (e.g., RPM) of generally rotatable blades 801 to a controller 810. Thus, the flow sensor 800 senses the flow rate of the water in the tube if the blades 801 are rotated by the water flowing through the flow sensor (or flow meter) 800.

In more detail, the blades 801 do not rotated during the flow of air, but they rotate from the flow of water through the flow sensor (or flow meter) 800.

However, other various sensing means may be adopted if they sense the flow rate of water.

Like this, the flow sensor 800 senses the flow rate of water flowing in the tube 730 and inputs the signal corresponding to the sensed result to the controller 810.

The controller 810 receives the flow rate sensing signal from the flow sensor 800 and determines whether water exists (e.g., in the water tank 500 and/or tube to the pump 600). If it is determined that water does not exist in the water tank 500 or tube, a warning device 820 is operated to notify the user of the result.

The warning device 820 may comprise a lamp which, when turned on, notifies the user of the non-existence or absence of water in the water tank 500, so that the user can visually recognize that water is not in the water tank when the lamp is turned on.

For example, if the controller 810 determines that water does not exist in the water tank 500 from the value or signal from the flow sensor 800, the controller 810 outputs a control signal to turn the lamp on. After that, if it is determined that water is recharged or in the tank 500 from the value or signal from the flow sensor 800, the controller 810 outputs a control signal to turn the lamp off.

Even after the water has been recharged into the water tank 500, if no flow rate of water exists (i.e., the flow rate determined by the flow sensor/meter 800 is 0), the controller 810 determines that water is not in the tank 500, and the lamp is turned on. In this case, the lamp may be turned off using a manually operated manipulator such as a switch.

Further, if it is determined that the flow rate of water is not sensed (i.e., is 0) and at the same time it is determined that the dispenser 300 or the ice maker 400 is not being used, the lamp is turned off by the control signal from the controller 810. In this case, if the dispenser 300 or the ice maker 400 is operated again and the flow rate of water is sensed (i.e., is >0), the lamp is not turned on by the control of the controller 810. Contrarily, if the dispenser 300 or the ice maker 400 is operated and the flow rate of water is not sensed (i.e., is 0), the lamp is turned on by the controller 810.

The warning device 820 may also or alternatively comprise a sound generator such as a speaker capable of generating a sound or voice to notify the user of the sensed state.

Of course, the lamp and the sound generator may be used together and operated at the same time.

Next, an explanation on the configuration in which the existence of the water in the water tank 500 is determined appropriately by the flow sensor 800 will be given hereinafter.

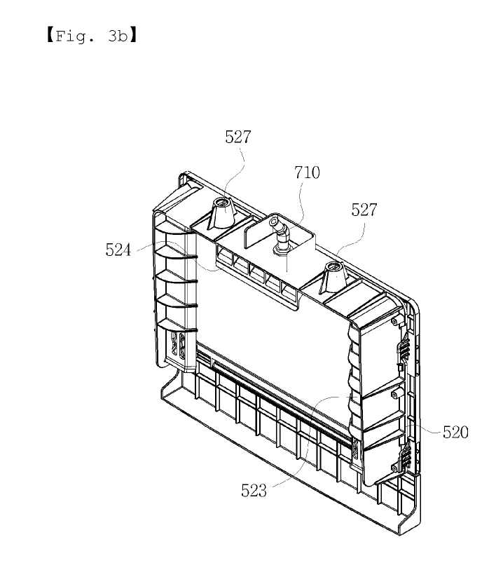

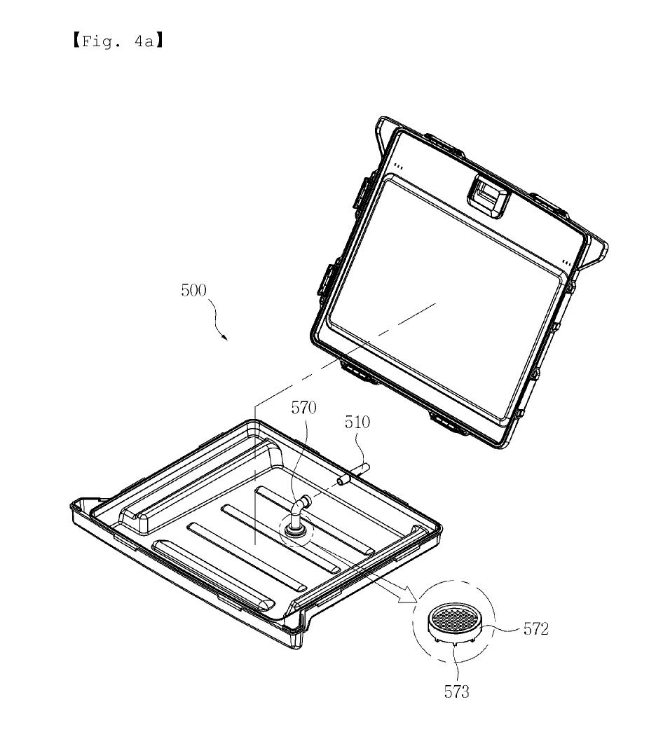

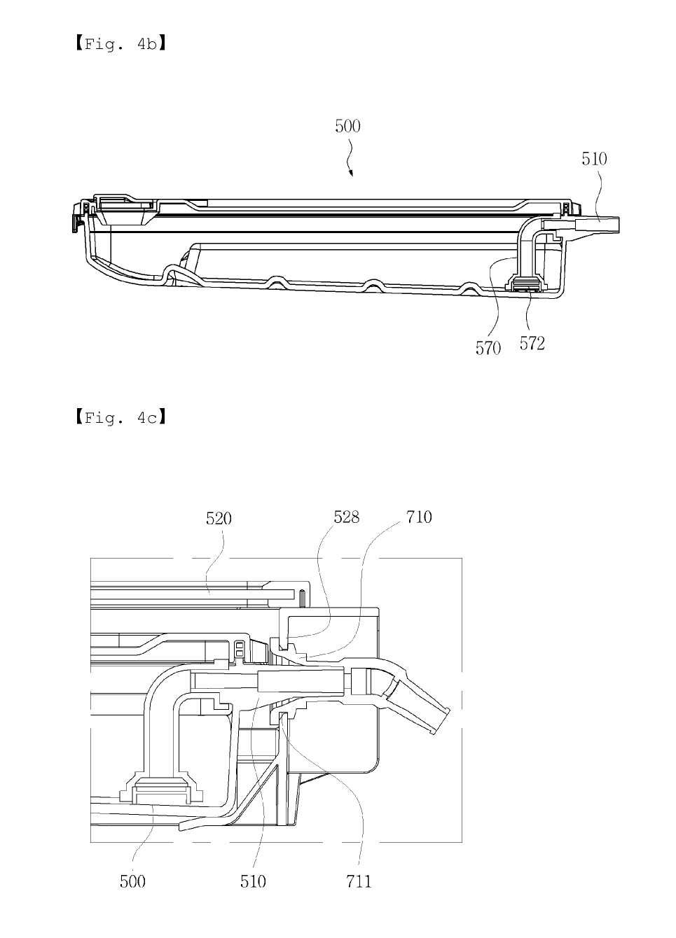

As shown in FIGS. 4a to 4c, the water tank 500 has an outlet 510 on the rear surface thereof to supply water to the ice maker 400 or the dispenser 300, and further, the water tank 500 has a pipe connector 570 extending from the interior thereof and connected to the outlet 510.

The pipe connector 570 desirably curves or bends toward the bottom surface of the water tank 500 from the rear wall or surface of the water tank 500.

Further, desirably, the pipe connector 570 has an inlet facing the bottom surface of the water tank 500 so as to enable determining whether water exists in the water tank 500 or whether the water exists to a given height.

In this case, the inlet of the pipe connector 570 may be separate or spaced apart from the bottom surface of the water tank 500, and only when water is present to a height from the bottom surface of the water tank 500 up to the inlet of the pipe connector 570, it is determined that water exists in the tank 500.

On the other hand, the pipe connector 570 may have a filter 572 on or in the inlet to filter or remove the foreign matters contained in the water that flows to the pump 600.

In this case, the filter 572 has a plurality of separate protrusions 573 along the outer periphery and/or on the underside surface of the filter 572 that are configured to contact the bottom surface of the water tank 500.

In this case, only when water is present to a height from the bottom surface of the water tank 500 above the protrusions 573, it is determined that water exists in the tank 500.

The present invention is applicable to a side-by-side refrigerator including a water tank, and to a top-mount type refrigerator or a French type refrigerator, through easy changes.

As described above, the refrigerator according to the present invention may include a water tank in which purified water, rather than tap water, is in, under or attached to a shelf in the interior of the cold storage unit and supplies water to the ice maker and the dispenser using a pump, and if the water in the water tank is below a predetermined amount or level, the user is notified to supply water or allow water to be supplied to the water tank, thereby making it convenient to use the ice maker and/or the dispenser.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A refrigerator comprising:
a water tank in an interior of a cold storage unit;
a pump adapted to pump water in the water tank to an ice maker or a dispenser;
a passage adapted to connect the water tank to the pump;
a flow sensor on or in fluid communication with the passage, configured to sense a flow rate of water; and
a controller adapted to receive a signal from the flow sensor and to determine whether water exists.

2. The refrigerator according to claim 1, wherein the flow sensor comprises a plurality of blades configured to be rotated by flowing water.

3. The refrigerator according to claim 1, further comprising a warning device adapted to notify a user of an absence of water.

4. The refrigerator according to claim 3, wherein the warning device displays a notice in accordance with a control signal from the controller.

5. The refrigerator according to claim 3, wherein the warning device comprises a lamp or a sound generator.

6. The refrigerator according to claim 4, wherein the control signal corresponds to an existence of water when the flow rate of water sensed by the flow sensor is zero, and the dispenser or the ice maker is not used; the control signal does not allow the warning device to be turned on when the flow rate of water is greater than zero; and the control signal allows the warning device to be turned on when the flow rate of water is zero and the dispenser or the ice maker is operated.

7. The refrigerator according to claim 1, wherein the water tank is configured to slide or move on a shelf in the interior of the cold storage unit, and comprises (i) an outlet on a rear surface thereof configured to supply water to the ice maker or the dispenser, and (ii) a pipe connector extending from the interior of the water tank and connected to the outlet.

8. The refrigerator according to claim 7, wherein the pipe connector curves or bends toward a bottom surface of the water tank from the rear surface of the water tank.

9. The refrigerator according to claim 8, wherein the pipe connector has an inlet facing the bottom surface of the water tank.

10. The refrigerator according to claim 9, wherein the inlet of the pipe connector is separate or spaced apart from the bottom surface of the water tank.

11. The refrigerator according to claim 10, wherein the pipe connector has a filter on or in the inlet.

12. The refrigerator according to claim 11, wherein the filter has a plurality of protrusions separate from each other along an outer periphery of the filter, configured to contact the bottom surface of the water tank.

13. The refrigerator according to claim 1, further comprising the ice maker and the dispenser.

14. The refrigerator according to claim 13, further comprising a freezer compartment, wherein the ice maker is in the freezer compartment.

15. The refrigerator according to claim 1, further comprising a door, wherein the dispenser is in the door.

16. The refrigerator according to claim 1, wherein the water in the water tank is purified water.

17. A method of warning a user of a refrigerator, comprising:
sensing or measuring a flow rate of water from a water tank in an interior of a cold storage unit of the refrigerator to a pump adapted to pump water in the water tank to an ice maker or a dispenser in the refrigerator;
determining whether water exists in the tank based on the flow rate; and
warning the user when it is determined that water does not exist in the tank.

18. The method according to claim 17, wherein warning the user comprises displaying a visual notice to the user.

19. The method according to claim 17, wherein warning the user comprises generating an audible sound to the user.

20. The method according to claim 17, wherein when:
the flow rate of water is zero, and the dispenser or the ice maker is not used, it is determined that water exists in the tank;
the flow rate of water is greater than zero, it is determined that water exists in the tank; and
the flow rate of water is zero and the dispenser or the ice maker is operated, it is determined that water does not exist in the tank.
